(19) United States
(12) Patent Application Publication
(10) Pub. No.: US 2014/0152196 A1
(43) Pub. Date: Jun. 5, 2014

(54) SAFETY ACTIVATION SYSTEM FOR LIGHTING INSTALLATIONS

(71) Applicants: Siang Ling Oon, Kowloon (HK); Kean Choong Low, Bayan Lepas (MY); Sidney Chu, Kowloon (HK)

(72) Inventors: Siang Ling Oon, Kowloon (HK); Kean Choong Low, Bayan Lepas (MY); Sidney Chu, Kowloon (HK)

(73) Assignee: GT BIOMESCILT LIGHT LIMITED, KOWLOON (HK)

(21) Appl. No.: 14/112,912

(22) PCT Filed: Apr. 23, 2012
(86) PCT No.: PCT/AU12/00425

§ 371 Date: Jan. 23, 2014

(30) Foreign Application Priority Data
Apr. 21, 2011 (AU) 2011901517

(51) Int. Cl. F21V 23/04; F21V 25/00; H05B 33/08

(52) U.S. Cl. CPC F21V 23/04; H05B 33/0806; F21V 25/00
USPC 315/362; 362/221

(57) ABSTRACT

Embodiments of the present invention reside in a safety activation system and method for a lighting installation. The safety activation system comprises an elongate housing for accommodating at least one illumination element. The elongate housing comprises an electrical connector at each opposing end and at least one of the ends of the houses comprises a switch. At least one switch is also provided on a surface of the elongate housing. Activation of all switches is required for electricity to be conducted to the at least one illumination element.

### FIELD OF THE INVENTION

The present invention relates to safety activation systems and methods for lighting installations. In particular, but not exclusively, the present invention relates to electric shock prevention systems and methods for lighting installations comprising light emitting diodes (LEDs).

### BACKGROUND OF THE INVENTION

With reference to FIG. 1, when installing an illumination element 2, such as a light tube comprising a plurality of LEDs, or a fluorescent tube, in a holder 4 of a lighting installation, an installer 6 is at risk of receiving an electric shock. For example, if a switch 8 controlling the mains power supply to the lighting installation is in the ON position and one end of the illumination element 2 is coupled to the live terminal 10, the installer 6 could be electrocuted if they touch connection pins 12 at the opposite end of the illumination element 2. Injury or death to the installer could result.

Hence, there is a need to prevent electrocution when installing illumination elements.

The reference to any prior art in this specification is not, and should not be taken as, an acknowledgement or any form of suggestion that the prior art forms part of the common general knowledge.

Throughout this specification and claims which follow, unless the context requires otherwise, the word “comprise”, and variations such as “comprises” and “comprising”, will be understood to imply the inclusion of a stated integer or step or group of integers or steps, but not the exclusion of any other integer or step or group of integers or steps.

### OBJECT OF THE INVENTION

It is a preferred object of the invention to provide an improved activation system for lighting installations that addresses or at least ameliorates the aforementioned problem of the prior art or provides a useful commercial alternative.

### SUMMARY OF THE INVENTION

Generally, the present invention relates to safety activation systems and methods for lighting installations comprising a plurality of switches that require simultaneous activation for electricity to be conducted. The arrangement of the switches is such that it is not possible for a user to contact any live part of the lighting installation, thus avoiding the risk of electrocution.

According to one aspect, but not necessarily the broadest aspect, the present invention resides in a safety activation system for a lighting installation comprising:

an elongate housing having at least one illumination element therein;

an electrical connector at each opposing end of the elongate housing, at least one of the ends comprising a switch; and

at least one switch provided on a surface of the elongate housing;

wherein activation of all switches is required for electricity to be conducted to the at least one illumination element.

Suitably, both opposing ends of the elongate housing comprise a switch.

Suitably, a surface of the elongate housing comprises a pair of spaced apart switches.

Activation of the switch(es) at the end(s) of the housing is effected by connection of the electrical connectors with electrical sockets of the lighting installation.

Activation of the switch(es) on the surface of the elongate housing is effected by a holder of the lighting installation.

Preferably, one or more of the switches are in the form of momentary toggle switches.

Suitably, the electrical connectors and/or one or more switches at opposing ends of the elongate housing are provided in end caps of the housing.

According to another aspect, but not necessarily the broadest aspect, the present invention resides in a method of preventing electrocution from a lighting installation including:

providing an elongate housing having:
at least one illumination element therein;
an electrical connector at each opposing end;
a switch at either or both ends; and
at least one switch on a surface of the elongate housing;

conducting electricity to the at least one illumination element when the elongate housing is inserted into a holder of the lighting installation and all of the switches are activated.

According to a further aspect, but not necessarily the broadest aspect, the present invention resides in a lighting installation comprising the aforementioned safety activation system.

According to a further aspect, but not necessarily the broadest aspect, the present invention resides in a safety activation system for a lighting installation comprising:

an elongate housing having at least one illumination element therein and an end cap at each opposing end;

an electrical connector extending through a respective one of the end caps;

at least one of the end caps comprising a switch therein; and

at least one switch provided on a surface of the elongate housing;

wherein activation of all switches is required for electricity to be conducted to the at least one illumination element.

Further aspects and/or features of the present invention will become apparent from the following detailed description,

### BRIEF DESCRIPTION OF THE DRAWINGS

In order that the invention may be readily understood and put into practical effect, reference will now be made to preferred embodiments of the present invention with reference to the accompanying drawings, wherein like reference numbers refer to identical elements. The drawings are provided by way of example only, wherein:

FIG. 1 is a schematic representation of a conventional lighting installation according to the prior art illustrating the problem to be addressed;

FIG. 2 is a sectional side view of a safety activation system for lighting installations according to embodiments of the present invention; and

FIG. 3 is a side view of the lighting installation shown in FIG. 2.

Skilled addressees will appreciate that elements in the drawings are illustrated for simplicity and clarity and have not necessarily been drawn to scale. For example, the relative dimensions of some of the elements in the drawings may be distorted to help improve understanding of embodiments of the present invention.

### DETAILED DESCRIPTION OF THE PREFERRED EMBODIMENTS

Embodiments of the present invention are directed to safety activation systems for lighting installations and will be described with reference to illumination elements in the form of light emitting diode (LED) tubes. However, it is envisaged that embodiments of the present invention can be used with lighting installations comprising other forms of illumination elements.

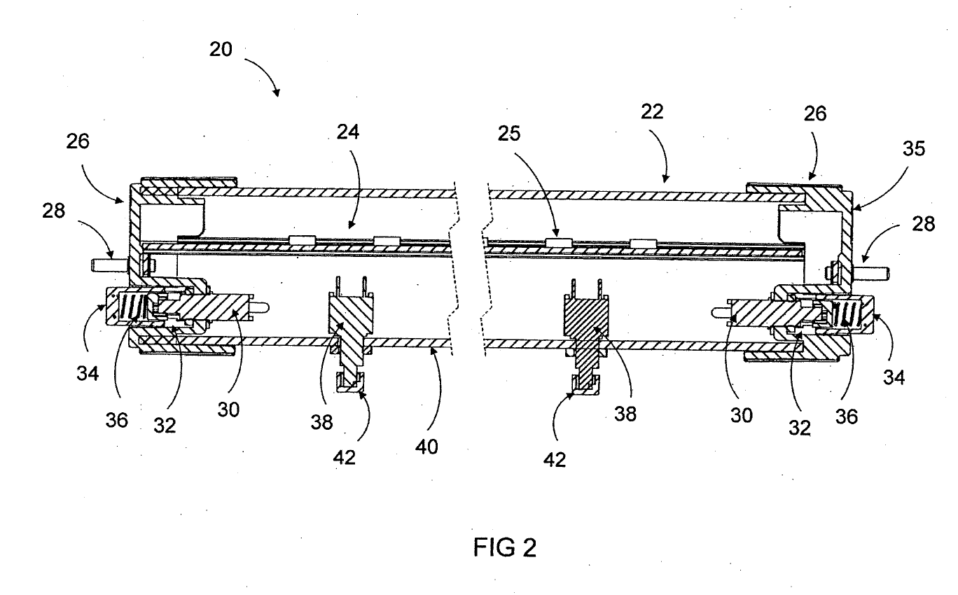

With reference to FIG. 2, a safety activation system 20 for a lighting installation comprises an elongate housing 22 having at least one illumination element 24 therein. In some embodiments, elongate housing 22 is in the form of a cylinder. In preferred embodiments, the illumination element 24 comprises a plurality of LEDs 25 coupled together in a string to form what is sometimes referred to as a “light engine”. Housing 22 comprises a pair of end caps 26, with an end cap 26 coupled to opposing ends of the housing 22 by any suitable means, such as a screw thread or a friction fit. In some embodiments, either or both of the end caps 26 are removable.

Housing 22 and end caps 26 are fabricated, molded or otherwise formed from any known suitable non-conducting material typically used for electrical fittings, such as suitable plastics materials.

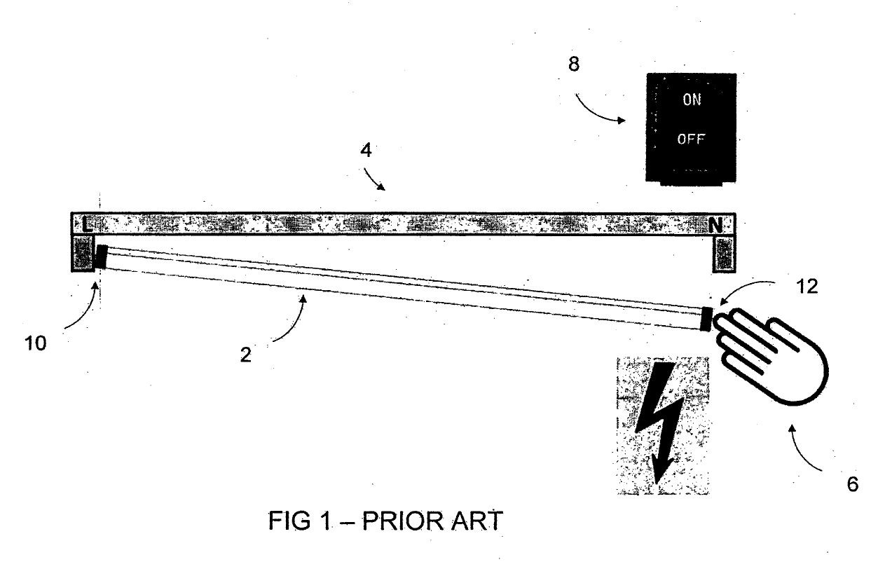

An electrical connector 28 is provided at each opposing end of the elongate housing 22 to provide an electrical connection between the housing 22 of the lighting apparatus and electrical sockets (not shown) of the holder 4 (shown in FIG. 1) of the lighting installation. In some embodiments, electrical connectors 28 pass through end caps 26. Electrical connectors 28 can be any suitable shape that is compatible with the shape of the corresponding sockets in the holder 4 of the lighting installation. Electrical connectors 28 will comply with any applicable standard according to the type of connection, such as, but not limited to, EN 60061-1.

At least one of the ends of the housing 22 comprises a switch 30. In the embodiment shown in FIG. 2, switches 30 are provided at both ends in recesses 32 in end caps 26. Switches 30 are actuated by buttons 34 which protrude beyond a surface 35 of end caps 26. A biasing device, such as helical spring 36, is provided between each button 34 and respective switch 30 to fill the gap between the switch 30 and the button 34 and to eliminate tolerances between the button and the switch. In preferred embodiments switches 30 are in the form of momentary toggle switches.

At least one switch 38 is provided on and through a surface 40 of the elongate housing 22. In embodiments where the elongate housing is cylindrical, at least one switch 38 is provided on and through the curved surface 40 of the elongate housing 22. In the embodiment shown in FIG. 2, a pair of spaced apart switches 38 is provided on and through surface 40 of the housing 22. Switch(es) 38 can provide electrical connection to the illumination element 24 in the event that switch(es) 30 is/are actuated. In preferred embodiments switches 38 are in the form of momentary toggle switches and comprise respective buttons 42.

In use, the activation of all switches, 30, 38 is required for electricity to be conducted to the at least one illumination element 24. In embodiments comprising a single switch 30 and a single switch 38, both switches 30, 38 must be actuated for electricity to be conducted to the at least one illumination element 24. In embodiments comprising two switches 30 and a single switch 38, or a single switch 30 and a pair of switches 38, all three switches must be actuated for electricity to be conducted to the at least one illumination element 24. In embodiments comprising two switches 30 and two switches 38, all four switches must be actuated for electricity to be conducted to the at least one illumination element.

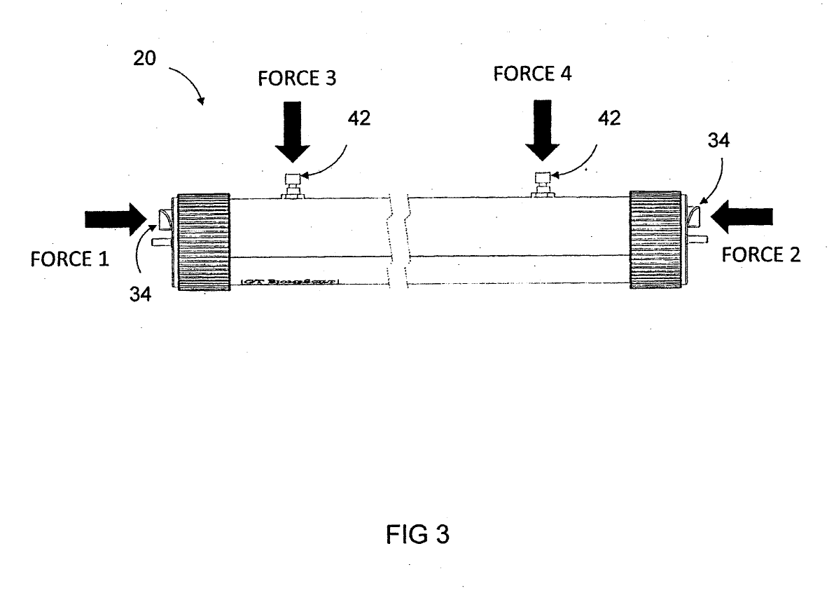

With reference to FIG. 3, activation of the switches 30 at the ends of the housing 22 via respective buttons 34 is effected by the application of Forces 1 and 2. This is caused by contact with sockets of the lighting installation due to the connection of the electrical connectors 28 with the electrical sockets of the lighting installation. Activation of the switches 38 on the surface 40 of the elongate housing 22 via respective buttons 42 is effected by the application of Forces 3 and 4 caused by contact with the holder 4 of the lighting installation.

Hence, switches 30, 38 can only be activated when the housing 22 is fully installed and holder 4 depresses buttons 34 of switches 30 and buttons 42 of switches 38. This ensures the safety of the installer and prevents the installer receiving an electric shock. If one of the electrical connectors 28 is exposed because the housing is not fully installed and the installer touches the exposed electrical connector, the installer will not receive an electric shock because at least one of the switches 30, 38 will not be activated.

In embodiments comprising a single switch 30 and a single switch 38, switch 38 is provided toward an end opposite the switch 30 such that both switches 30, 38 cannot be activated whilst one of the electrical connectors 28 is exposed.

According to another aspect, embodiments of the present invention are directed to a method of preventing electrocution from a lighting installation including providing the elongate housing 22 having, at least one illumination element 24 therein. The method includes providing an electrical connector 28 at each opposing end of the elongate housing 22 and providing a switch at one or both of the ends of the housing 22. The method includes providing at least one switch 38 on and through the surface 40 of the elongate housing 22, wherein activation of all switches is required for electricity to be conducted to the at least one illumination element 24.

According to a further aspect, embodiments of the present invention reside in a lighting installation comprising the safety activation system as described herein.

Hence, embodiments of the present invention provide solutions for alleviating the problems of the prior art. Embodiments of the safety activation system comprise a plurality of switches 30, 38 that require simultaneous activation for electricity to be conducted. The arrangement of the switches is such that it is not possible for a user to contact any live part of the lighting installation, thus avoiding the risk of electrocution when installing the illumination element.

The safety activation system according to the present invention can be used with known holders 4 of existing installations such that new holders do not need to be fitted.

Throughout the specification the aim has been to describe the preferred embodiments of the invention without limiting the invention to any one embodiment or specific collection of features. It is to be appreciated by those of skill in the art that various modifications and changes can be made in the particular embodiments exemplified without departing from the scope of the present invention.

1. A safety activation system for a lighting installation comprising:
an elongate housing having at least one illumination element therein;
an electrical connector at each opposing end of the elongate housing, at least one of the ends comprising a switch; and
at least one switch provided on a surface of the elongate housing;
wherein activation of all switches is required for electricity to be conducted to the at least one illumination element.

2. The safety activation system of claim 1, wherein both opposing ends of the elongate housing comprise a switch.

3. The safety activation system of claim 1, wherein a surface of the elongate housing comprises a pair of spaced apart switches.

4. The safety activation system of claim 1, wherein the elongate housing is cylindrical and the at least one switch is provided on a curved surface of the elongate housing.

5. The safety activation system of claim 1, wherein activation of the switch(es) at the end(s) of the housing is effected by connection of the electrical connectors with electrical sockets of the lighting installation.

6. The safety activation system of claim 1, wherein activation of the switch(es) on the surface of the elongate housing is effected by contact with a holder of the lighting installation.

7. The safety activation system of claim 1, wherein one or more of the switches are in the form of momentary toggle switches.

8. The safety activation system of claim 1, wherein each end of the elongate housing comprises an end cap.

9. The safety activation system of claim 8, wherein at least one of the end caps is removable.

10. The safety activation system of claim 8, wherein the electrical connectors pass through the end caps.

11. The safety activation system of claim 8, wherein at least one of the end caps comprises a recess for accommodating the switch at one of the ends of the elongate housing.

12. A lighting installation comprising the safety activation system as claimed in claim 1.

13. A method of preventing electrocution from a lighting installation including:
providing an elongate housing having:
at least one illumination element therein;
an electrical connector at each opposing end;
a switch at either or both ends; and
at least one switch on a surface of the elongate housing;
conducting electricity to the at least one illumination element when the elongate housing is inserted into a holder of the lighting installation and all of the switches are activated.

14. A safety activation system for a lighting installation comprising:
an elongate housing having at least one illumination element therein;
an end cap at each opposing end of the elongate housing;
an electrical connector extending through a respective one of the end caps;
at least one of the end caps comprising a switch therein; and
at least one switch provided on a surface of the elongate housing;
wherein activation of all switches is required for electricity to be conducted to the at least one illumination element.

15. The safety activation system of claim 14, wherein activation of the at least one switch at the end of the elongate housing is effected by connection of the electrical connectors with electrical sockets of the lighting installation.

16. The safety activation system of claim 14, wherein activation of the at least one switch on the surface of the elongate housing is effected by contact with a holder of the lighting installation.
